(19) United States
(12) Patent Application Publication
(10) Pub. No.: US 2020/0151642 A1
(43) Pub. Date: May 14, 2020

(54) SYSTEM AND METHOD FOR CONTROLLING CAMPAIGN STREAMING

(71) Applicant: Capital One Services, LLC, McLean, VA (US)

(72) Inventors: Gopi KANCHARLA, Frisco, TX (US); Parvesh KUMAR, Plano, TX (US); Raman BAJAJ, Frisco, TX (US); James LAND, The Colony, TX (US); Praveen TANDRA, Allen, TX (US); Janardhan PRABHAKARA, Allen, TX (US); Terry NI, McKinney, TX (US); Sanjiv YAJNIK, McLean, VA (US); Arjun DUGAL, Dallas, TX (US)

(73) Assignee: Capital One Services, LLC, McLean, VA (US)

(21) Appl. No.: 16/191,345

(22) Filed: Nov. 14, 2018

(51) Int. Cl. G06Q 10/06; G06Q 30/02; G06F 9/48

(52) U.S. Cl. CPC G06Q 10/06316; G06F 9/4881; G06Q 30/0261; G06Q 30/0269

(57) ABSTRACT

A campaign server is disclosed which includes a multi-level queue architecture that isolates campaign processing from the delays and inconsistencies of target population information retrieval. Each queue level may be intelligently controlled to provide backpressure in accordance with both processing demands of coupled messaging agents and available resources. Queues may be controlled to speed up or slow down customer information retrieval in accordance with the progress of campaign processing. Customer information is combined with campaign content by a set of messaging agents, each of which independently process a campaign for a target. Because messaging agents operate independently of each other, the potential for bottlenecks often encountered during campaign processing is removed. The set of messaging agents may be dynamically modified during operation to add or remove messaging agents in accordance with the processing needs of a campaign and the available resources of the campaign server. Using this feature a campaign server may auto-scale the messaging agents deployed for campaign processing to optimize campaign streaming in view of available resources.

### BACKGROUND

Companies invest heavily in marketing campaigns to attract or otherwise influence existing and potential customers. One aspect of marketing involves streaming advertising content to target populations to attract new customers to product and service offerings. Many companies collect target population information to control and/or customize future campaign delivery for maximum impact. The information may include basic information, such as email addresses, and/or more complex information, such as the type of accounts held by the customer, previous purchase histories, previous campaign successes, etc. Such target population information may be used to tailor the marketing content to the particular target population, to thereby improve marketing campaign success and drive company revenue.

However, as marketing campaigns continue to grow more sophisticated and the population of target populations continues to grow so does the amount of data that needs to be processed to support a campaign. The sheer volume of data may strain system resources, resulting in processing bottlenecks that impede effective campaign delivery. It would be desirable to identify a system, method and architecture for campaign delivery that intelligently uses company resources to reduce bottlenecks and maximize throughput.

### SUMMARY

According to one aspect, a campaign server includes an interface for receiving a job request related to a campaign to be streamed to a plurality of target populations The campaign server also includes a plurality of queues comprising a plurality of entries, each entry for storing target population information retrieved from a coupled target population data store, and a first backpressure controller to control forwarding of target population information retrieved from the target population data store to the plurality of queues in response to availability of entries in the plurality of queues. The campaign server further includes a reactive queue comprising a plurality of entries for storing target population information retrieved from the plurality of queues and a second backpressure controller to control retrieval of target population information from the plurality of queues in response to availability of entries in the reactive queue. The campaign server also includes a messaging agent builder, coupled to the reactive queue and adapted to dynamically control a population of messaging agents and a plurality of messaging agents, each messaging agent for generating campaign content and forwarding the campaign content to target populations identified by target population information retrieved from the reactive queue by the messaging agent.

According to another aspect, a method for streaming campaigns to target populations coupled to a campaign server by a network includes the steps of receiving a job request related to a campaign to be streamed to a plurality of target populations and retrieving target population information for the plurality of target populations from a coupled target population data store. The method includes the steps of selectively storing the target population information in a queue selected from a plurality of queues, including precluding storage of target population information in response to unavailability of the plurality of queues. The method includes forwarding target population information from the plurality of queues to a reactive queue including precluding the forwarding of target population information in response to unavailability of the reactive queue. The method includes dynamically controlling a population of messaging agents, including generating a plurality of messaging agents and retrieving, by each messaging agent, target population information from the reactive queue and processing the campaign, at each messaging agent, for target populations identified by target population information retrieved from the reactive queue by the messaging agent, including forwarding campaign content to the target populations.

According to a further aspect, a method of streaming campaigns target populations coupled to a campaign server by a network includes the steps of requesting a job associated with a campaign, including identifying a plurality of target populations to receive campaign control information populating attributes of a dynamic campaign service, the attributes comprising a queue size, a queue number and a reactive queue size. The method includes deploying the dynamic campaign service, including building a plurality of queues in accordance with the queue size and queue number, building a reactive queue in accordance with the reactive queue size and deploying a plurality of messaging agents. The method includes forwarding target population information for each of the plurality of target populations to the plurality of queues, including precluding the forwarding to the plurality of queues in response backpressure at the plurality of queues. The method further includes forwarding target population information from the plurality of queues to the reactive queue including precluding the forwarding to the reactive queue in response to backpressure from the queue. The method includes retrieving, by each messaging agent, target population information from the reactive queue and processing the campaign, by each messaging agent, for target populations identified by target population information retrieved from the reactive queue by the messaging agent, including forwarding campaign content to the target populations.

With such an arrangement, campaign processing may be insulated from the delays of target population information retrieval because processing agents can stream data from local queues managed for optimum capacity. Intelligent queue control comprising two levels of backpressure ensures that target population information is steadily provided to processing agents. Dynamic message agent population methods allow messaging agents to be added or deleted during campaign execution, permitting the campaign server to intelligently manage the campaign in view of available computing resources, reducing the potential of bottlenecks and campaign delivery failures.

### BRIEF DESCRIPTION OF THE DRAWINGS

FIG. 1 is a block diagram of a system comprising a campaign server including aspects of an embodiment of the present invention;

FIG. 2 is a more detailed block diagram of exemplary components of a campaign server which may be used in the system of FIG. 1;

FIG. 3 is a data flow diagram provided to illustrate exemplary steps that may be performed by a campaign server according to an example embodiment of the present invention which may be used to distribute campaign content within the system of FIG. 1;

FIG. 4 is a flow diagram illustrating exemplary steps that may be performed by a first backpressure control process of the campaign server of FIG. 3; and

FIG. 5 is a flow diagram illustrating exemplary steps that may be performed by a second backpressure control process of the campaign server of FIG. 3.

### DEFINITIONS

As used herein, unless specifically indicated otherwise, the word “or” is used in the inclusive sense of “and/or” and not the exclusive sense of “either/or.”

Any issued U.S. Patents, allowed applications, published foreign applications, and references that are cited herein are hereby incorporated by reference to the same extent as if each was specifically and individually indicated to be incorporated by reference.

In order for example embodiments of the present invention to be more readily understood, certain terms are first defined below. Additional definitions for the following terms and other terms are set forth throughout the specification.

Array Blocking Queue means a bounded queue in which a fixed-sized array holds elements inserted by producers and extracted by consumers.

Consumer means a messaging agent that retrieves information from a reactive queue.

Reactive Queue means a queue that divests information in response to pull requests from consumers.

System/Component/Unit the terms “system”, “component” and “unit” are intended to mean a computer-related entity, either hardware, a combination of hardware and software, software, or software in execution, examples of which are described herein. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

Queue means a portion of memory including a plurality of entries for buffering data items received from one component prior to forwarding to a second component. Queues include indexing logic for identifying locations in the queue for insertion and removal of data items and are generally referred to according to the protocol following for draining and filling the queues. Examples of queues include but are not limited to First-In-First-Out (FIFO), Last-In-First-Out (LIFO), and Array Blocking Queues.

Target means the intended recipient of a campaign collateral.

### DETAILED DESCRIPTION

Many existing campaign servers experience performance issues related to retrieval of target population information. For example, a lack of coordination between consumers of the customer information and the servers of customer information may result in bursty campaign processing, straining campaign resources and causing processing bottlenecks. According to one aspect, an improved campaign server overcomes these issues via a multi-level queue architecture that isolates campaign processing from the delays and inconsistencies of target population information retrieval. In one embodiment each queue level is intelligently controlled to provide backpressure in accordance with both processing demands of coupled messaging agents and available resources. For example, the queues may be controlled to speed up or slow down customer information retrieval in accordance with the progress of campaign processing. Customer information is combined with campaign content by a set of messaging agents, each of which independently process a campaign for a target. Because messaging agents operate independently of each other, the potential for bottlenecks often encountered during campaign processing is removed. In one embodiment, the set of messaging agents may be dynamically modified during operation to add or remove messaging agents in accordance with the processing needs of a campaign and the available resources of the campaign server. Using this feature a campaign server may auto-scale the messaging agents deployed for campaign processing to optimize campaign streaming in view of available resources.

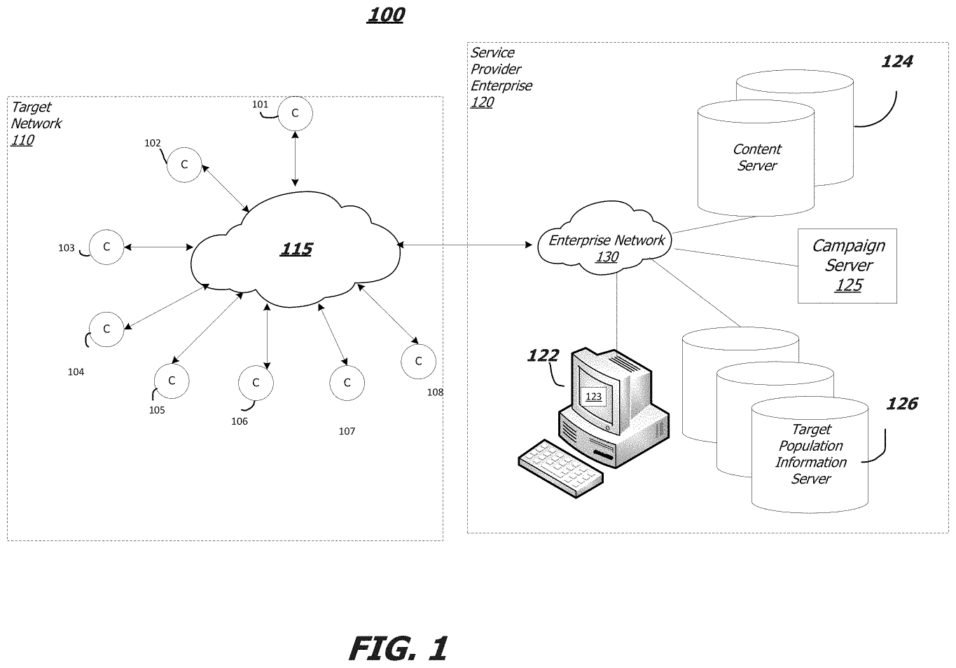

FIG. 1 is a block diagram of a system 100 including a target network 110 comprised of a plurality of target customers 101-108 coupled via a network 115 to a service provider enterprise 120.

Target customers 101-108 may be any customer device capable of receiving and displaying campaign content to a user. Although only eight devices are shown, it is appreciated that a target network may comprise hundreds of thousands of consumers or more. Such devices include, but are not limited to a computer device, or communications device including, e.g., a server, a network appliance, a personal computer (PC), a workstation, a mobile device, a phone, a handheld PC, a personal digital assistant (PDA), a thin client device, a fat client device, an Internet browser, or other device. Target customers 101-108 also may be a mobile device; for example, a mobile device may include an iPhone, iPod, iPad from Apple® or any other mobile device running Apple's iOS operating system, any device running Microsoft's Windows® Mobile operating system, and/or any other smartphone or like wearable mobile device.

In some examples, network 115 may be one or more of a wireless network, a wired network or any combination of wireless network and wired network and may be configured to connect customers in target network 110 to service provider enterprise 120. For example, network 115 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g, Bluetooth, Near Field Communication (NFC), Radio Frequency Identification (RFID), Wi-Fi, and/or the like.

In addition, network 115 may include, without limitation, telephone lines, fiber optics, IEEE Ethernet 902.3, a wide area network (“WAN”), a wireless personal area network (“WPAN”), a local area network (“LAN”), or a global network such as the Internet. In addition, network 115 may support an Internet network, a wireless communication network, a cellular network, or the like, or any combination thereof. Network 115 may further include one network, or any number of the exemplary types of networks mentioned above, operating as a stand-alone network or in cooperation with each other. Network 115 may utilize one or more protocols of one or more network elements to which they are communicatively coupled. Network 115 may translate to or from other protocols to one or more protocols of network devices.

Service Provider enterprise 120 includes resources of a service provider, where a service provider is a company that provides one or more of products and services to customers. In some embodiments, a service provider may be an enterprise that provides services for delivering marketing content to existing and potential customers of a third party enterprise. In some embodiments, a service provider may be an enterprise that provides numerous products and services to customers and includes resources that may be dedicated to delivering marketing content to existing and potential consumers. The service provider may include an enterprise network 130 that secures communication between interconnected service provider resources. Similar to network 115, the enterprise network 130 may comprise wireless or wireline communication or combination technology and may use protocols such as those of network 115.

The resources of the service provider enterprise 120 may include applications, processing components and storage resources, each of which may comprise both those owned and dedicated specifically to the enterprise, and those licensed or leveraged as part of third-party arrangements, such as cloud-based services, applications, and resources. Components of the service provider enterprise 120 are shown to include a campaign server 125, a content server 124 and a target information server 126. In one embodiment, both the content server 124 and the target information server 126 comprise data storage resources which may be used to respectively store campaign content and campaign target information. Although the data storage resources are shown to be discrete entities, it is appreciated that both the content server 124 and target information server 126 may be comprised of coupled data resources comprising any combination of local storage, distributed data center storage or cloud-based storage.

The service provider enterprise 120 is also shown to include a workstation 122. Workstation 122 is a computing device capable of displaying information and options to a user and communicating campaign build instructions from the user to the campaign server 125. In one embodiment, the workstation may include an interface 123, comprised of software and/or hardware configured for communications with a campaign service application supported by the campaign server. For example, a user at the workstation 122 may input campaign control information including campaign attributes such as campaign content, campaign target population information, campaign schedule, etc. to the campaign server 125 to define and deploy a campaign.

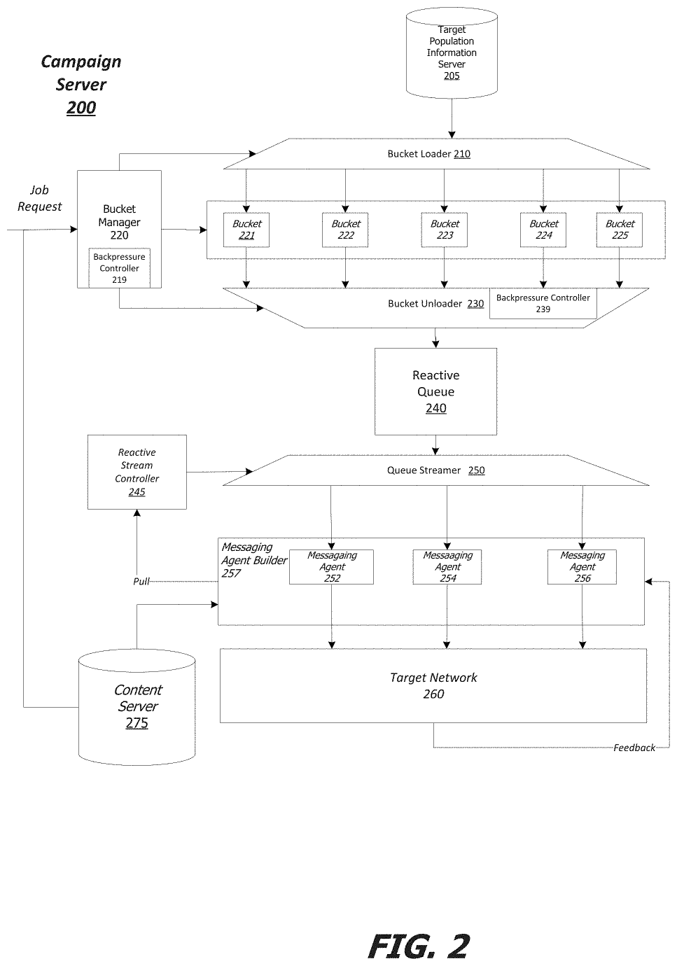

FIG. 2 is a block diagram of exemplary components of a campaign server 200. Although certain functionality is described below as being performed by certain components, it is appreciated that the delineation of functionality between the components is a matter of design, and any attribution of a function to a component below is not meant to limit or otherwise restrict the example embodiments of the invention.

The campaign server in one embodiment includes a plurality of buckets 221, 222, 223, 224 and 225. In an example embodiment, a ‘bucket’ is a queue comprising a predetermined number of entries, each entry for storing target population information retrieved from target information server 205. In an embodiment, the number and size of buckets may be determined based upon campaign control information received from the user, for example based on the size of a target population or a complexity of a campaign type. Although five buckets are shown, embodiments of the present invention are not limited to any particular number of buckets/queues.

In an example embodiment, the buckets are provisioned or generated by a bucket manager 220 in response to receipt of a job request by a bucket manager 220. Provisioning a bucket may include allocating a portion of a memory resource of the service provider to the bucket and forwarding indexing information associated with the bucket to a bucket loader 210 and a bucket unloader 230. The buckets may be indexed using a variety of queue protocols which prioritize queue data for output, including First-In-First-Out (FIFO), Last-In-Last-Out (LIFO), or prioritization based on one or more aspects of the campaign control information. For example, the queues may prioritize data for release based on target attributes such as target geography or based on campaign attributes such as campaign schedule.

A bucket loader 210 may be disposed between the target information server 205 and the buckets 221-225. The bucket loader may be configured to transfer target population information from the target information server 205 to the queues when the queues have space available to accept such information. In an example embodiment, the bucket loader 210 includes backpressure controller 219 which may preclude transfer of the target population information to the queues when the queues reach a threshold capacity. In an example embodiment, backpressure controller 219 signals the bucket loader 210 to stop forwarding target population information to buckets 221-225 when the buckets have reached a threshold capacity. The threshold capacity may advantageously be selected to account for the time delay between notifying the bucket loader to stop filling the buckets and the bucket loaders ability to stop the flow of target population information, in order to prevent data loss. Thus, a selected threshold capacity in some embodiments is one that leaves sufficient buffer capacity in the queues to accommodate all target population information that may be received while the bucket loader is stopping target population information streaming from the target information server 205. The threshold may be a resource-dependent calculation which takes into consideration, among other system delays, network bandwidth availability, target population server resource delays, target population record size and content server queue management delays.

A bucket unloader 230 may be disposed between a reactive queue 240 and the plurality of buckets 221-225. The bucket unloader 230 may perform a plurality of tasks including monitoring the buckets 221-225 for the presence of target information and streaming target information from the different buckets into the reactive queue 240. A backpressure controller 239 of bucket unloader may provide information related to the availability of the reactive queue to accept additional target data.

In an example embodiment, the reactive queue is an array blocking queue comprising a fixed-size array that holds target data inserted by producers (i.e., target information server 205/bucket loader 210/buckets 221-225) and extracted by consumers (messaging agents 252, 254, 256). It may be managed as a bounded reactive queue that prioritizes data output using FIFO (first-in-first-out) protocols. A bounded queue is one that defines an upper bound on the number of elements it can store at the same time. A blocking queue is one that blocks attempts to add and remove elements from the queue when, respectively, the queue is full, or the queue is empty. In an example embodiment an array blocking queue protocol is used to drive the backpressure controller 239 to inhibit bucket unloader 230 from forwarding target population information from buckets 221-225 to the reactive queue 240. For example, in one embodiment, an array blocking queue may generated as a data structure using a Java® Collections framework ArrayBlockingQueue class, where array indexing is managed to produce data in a FIFO (first-in, first-out) order. Requests to retrieve data from an ArrayBlockingQueue class are denied when no data is in the queue, provides a hard backpressure signal to the bucket unloader 240.

Requests to insert data into an ArrayBlockingQueue class are denied when there is no data in the queue. In embodiments where the reactive queue 240 is implemented as a Java® ArrayBlockingQueue, denied requests return an IllegalStateException. Java® ArrayBlockingQueues advantageously include defined processes for obtaining queue state information, such as the remaining capacity (i.e., number of elements that the reactive queue 240 can accept before blocking). Such state information may advantageously be used by the bucket unloader backpresser controller 230 to throttle down target population information retrieval.

In addition, the Java® ArrayBlockingQueues include defined processes controlling queue draining, allowing one or more entries to be drained at a time, which may be used by queue streamer 250 and reactive stream controller 245 to direct target population to requesting messaging agents 252, 254, 256.

As shown in FIG. 2, the messaging agents 252, 254, 256 are coupled to the reactive queue 240 via a queue streamer 250. In an example embodiment, the queue streamer may perform a reverse multiplex operation, operating in response to selection input from a reactive stream controller 245 to direct target population information to particular messaging agents in response to pull requests from the respsective messaging agents. In an example embodiment, an agent comprises software code that is programmed to perform a task. A messaging agent builder 257 may generate multiple instances of different forms of program code, in accordance with the selected campaign content as messaging agents, and deploy the messaging agents to operate on different processors within the network 115. For example, depending upon the campaign, messaging agents may be deployed to different resources based upon the geography of the resource and it proximity to the target population Tasks performed by messaging agents may include, but not be limited to, populating and delivering email, text and/or advertising content to customers in the target network 260.

The one or more messages may each be uniquely customized for each of the plurality of respective customers responsive to campaign content and information that is personal to each target. For example, in one embodiment campaign content may selected form a pre-existing set of campaign collateral templates, such as email templates, text templates, advertising windows and the like. In some embodiments, a messaging agent may populate the campaign collateral template with target specific information. In other embodiments an messaging agent may select among a set of templates allocated to a campaign based on attributes of the target, such account information, prior purchase history, determined delivery preferences, etc. Each messaging agent may be deployed to different resources throughout a network 115 to drive campaign delivery, and may communicate with network endpoint to coordinate delivery to particular targets, for example by displaying advertising on a third party web page. Each messaging agent may also communicate back to the campaign server, for example, providing additional target population information, such as interest manifested by click behavior, that may assist future directed campaign efforts.

As will be described in more detail below, according to one aspect the messaging agents 252, 254 and 256 are deployed by a messaging agent generator 257 of the campaign server at campaign initialization. The number of messaging agents deployed at initialization may vary according to campaign control information input by the user. For example, campaign control information that relates to the complexity of the campaign, such as the size of the target population and the processing load imposed by the campaign, as well as amount of resources available to the campaign server, may factor into the determination of the number of messaging agents that may be deployed. In one aspect, the number of messaging agents 252, 254, 256 may automatically vary during campaign execution, auto-scaling in accordance with variances in resource availability at the campaign server 200. That is, as available resources decline, the campaign server may reduce the number of deployed messaging agents, and as more resources become available, the campaign server may increase the number of deployed messaging agents.

As mentioned above, in an example embodiment, the reactive queue 240 may be a reactive queue that operates in response to ‘pull’ requests from messaging agents 252, 254, 256. While only three messaging agents are shown, it can be appreciated that one feature of the present invention is the ability to deploy as many messaging agents as system resources allow in order to provide massive parallel processing of campaign delivery, thereby increasing campaign efficiency and throughput. The volume is further enhanced by the fact that the agents are configured to independently operate on their own tasks. As such, performance issues encountered by one messaging agent will have minimal impact on overall campaign effectiveness. In addition, differences in processing complexity by the respective agents as they work on different campaign content, target population and delivery tasks do result in overall campaign processing delays.

In addition, in contrast to prior art implementations where target population information delivery is driven by the data source, in one aspect each messaging agent drives its own consumption by pulling from the reactive queue 240 when processing capability becomes available at the agent, thereby minimizing delays and further increasing campaign throughput.

The queue streamer 250 works cooperatively with the reactive stream controller 245 to direct target population information to available messaging agents 252, 254, 256.

Messaging agents combine campaign content, retrieved from content server 275, with target population information and feedback from previous campaign efforts to generate and delivery campaign messaging to customers in target network 260.

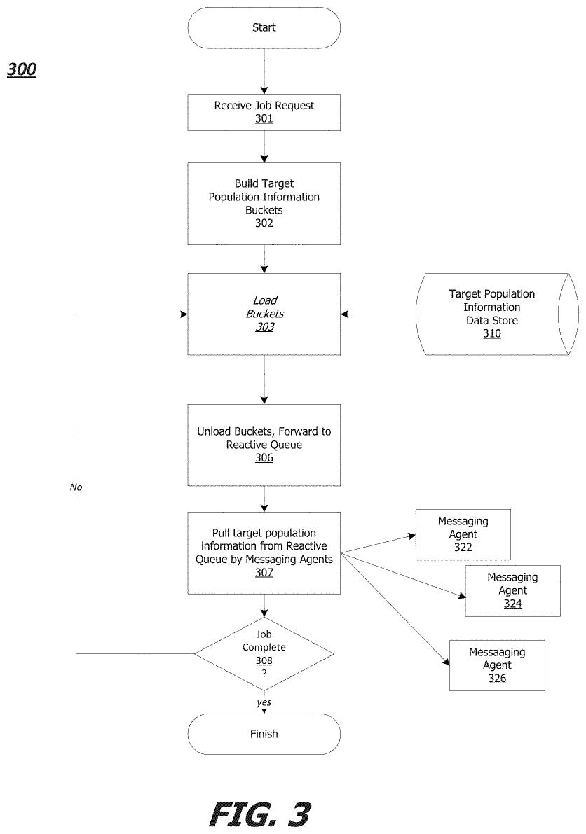

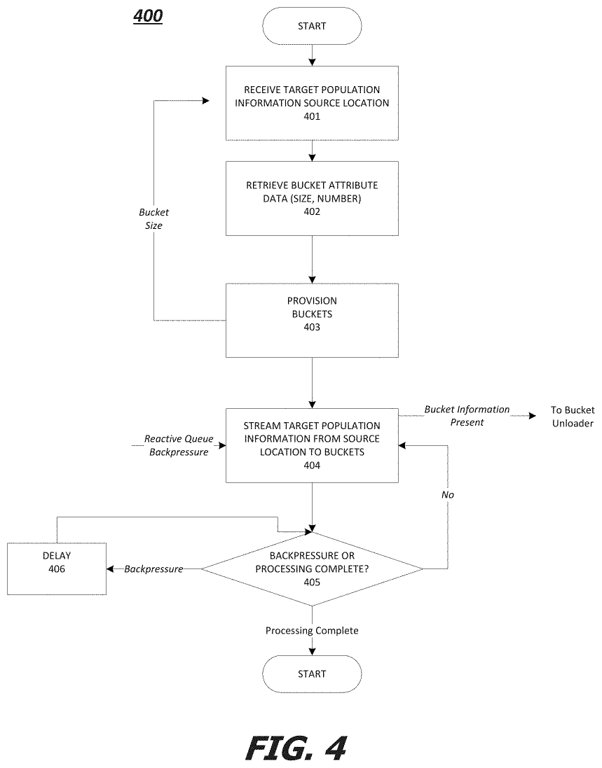

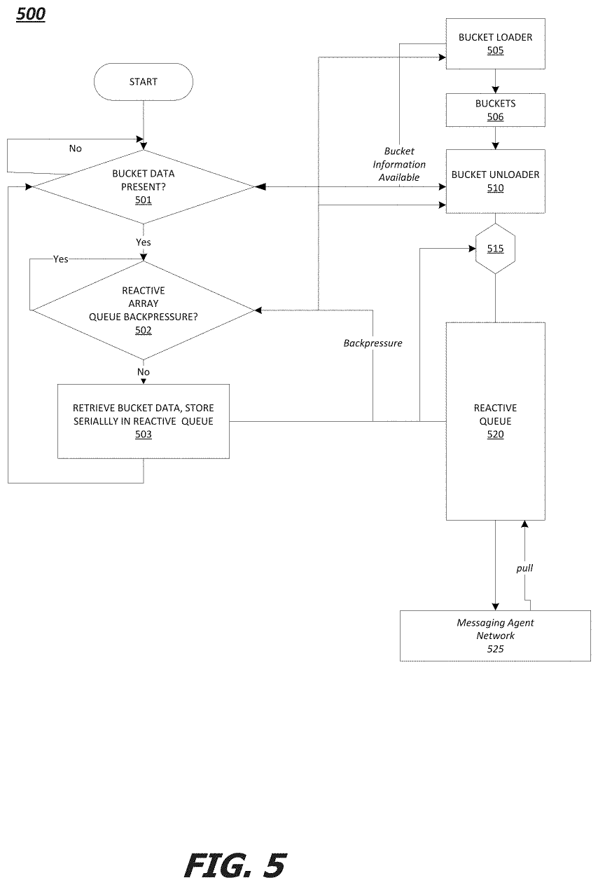

FIG. 3 is a flow diagram illustrating exemplary steps 300 that may be performed for campaign streaming by a campaign server configured according to example embodiments of the invention. At step 301, the campaign server receives a job request, which may include campaign control information. At step 302 buckets to receive incoming target population information may be built, allocated, and/or configured. At step 303, the campaign server begins to load the buckets with target population information retrieved from a target population information data store 310. In an example embodiment, and as will be described in more detail in FIG. 4, the loading operates or may be initiated in response to a backpressure throttling mechanism. At step 306, the buckets are unloaded and forwarded to a reactive queue, responsive to reactive queue backpressure features as will be described with regard to FIG. 5. At step 307, target population information is pulled from the reactive queue and forwarded to messaging agents 322, 324, 326. The process steps of loading and unloading buckets and pulling from the active blocking queue may continue until all target population information has been streamed through the campaign, and the job is determined complete at step 308.

FIG. 4 illustrates exemplary steps of a process 400 that may be performed by a bucket manager implemented according to aspects of an example embodiment of this invention. At step 401 the bucket manager receives campaign content information, including information related to target population size and campaign complexity. In an example embodiment, at step 402, the bucket manager may also receive or calculate bucket attribute data including the size and number of entries to be allocated to each bucket. In some embodiments, different buckets may comprise different numbers of entries and may be populated using target population information of different types or classes. In other embodiments, the size and number of entries may be predetermined values reflecting resources available to the campaign server. Alternatively, the size and number of entries in a bucket may be selected based on historical campaign performance data related to optimum information throughput for campaigns.

Once the size or number of buckets is determined, at step 403 the bucket manager may provision a portion of memory for storing data for each bucket, and at step 404 may begin the process of streaming target population information into the buckets. In some embodiments, the bucket manager may use downstream information from the reactive queue to regulate a rate of data streaming. In an example embodiment, the bucket manager may forward bucket state information to the bucket unloader, to signal the bucket unloader that there is target population information present in the buckets.

As mentioned above, bucket loading functionality may operate in response to a backpressure mechanism that throttles the rate of target population information streaming in accordance with the availability of bucket entries with an aim of ensuring maximum buffer fullness without bucket overflow. Accordingly, a threshold value is associated with the buckets. The threshold value may be a fullness indicator associated with a number of unused bucket entries. It is appreciated that it may be difficult to put a hard stop to the streaming of target population information as there are inherent system delays associated with signaling the target population data store to stop forwarding data and the time the last piece of forwarded data makes it to the buckets. The delay may vary based on network speed, target population data store performance and protocols, target population information size and other network performance considerations known to those in the art.

When the buckets reach the threshold, at step 405 a backpressure detection mechanism of the bucket unloader causes the bucket unloader to delay retrieval of entries at step 406. As described above with regard to FIG. 2, the backpressure detection mechanism may use information provided by the Java® ArrayBlockingQueue related to the number of remaining entries, if any. Retrieval may be delayed until backpressure is determined to be relieved at step 405, at which point the process returns to step 404 as more target population information is retrieved and forwarded to queues. The process may continue until it is determined at step 405 that all target population information for the campaign has been processed.

In some aspects, similar to using a threshold value to determine when the buckets are full, the mechanism for determining that backpressure is relieved may also take into account network delay times in retrieving data from the target population data store. Accordingly, some embodiments may request target population information from the data store prior to when the buckets are able to accept it, with an understanding based on historical server behavior that bucket space is likely to be available by the time the data arrives.

Because the backpressure signal from the bucket loader takes into account not only the fullness of the buffers but the availability of the reactive buffer (which is driven by actual agent consumption) the rate of data flow into the buckets may be customized to the needs of the campaign. By dynamically deploying and removing the messaging agents to optimally support the campaign in view of system resources, campaign delivery may be optimized the specific system architecture in which it is deployed. Such an arrangement drastically improves the performance of the disclosed architecture over prior art systems which have generally sought to limit the number of campaign delivery agents to conserve system resources, often resulting in a need to slow down data delivery to reduce the potential for processing bottlenecks and lost data.

FIG. 5 is a data flow diagram illustrating exemplary steps that may be performed by a bucket unloader as part of reactive queue management process 500 according to aspects of an example embodiment of this invention. When at step 501 the bucket unloader 510 receives the signal from the bucket loader 505 that there is information in the buckets, at step 502 the bucket unloader examines the status of the reactive queue. As mentioned above, the protocol of the reactive queue 520 blocks attempts to receive data when the queue is full. A backpressure signal, representing availability of the reactive queue, is forwarded to bucket unloader 510. In one embodiment, the backpressure signal is also advantageously forwarded to bucket loader 505, which assists in regulating the rate of data stream to buckets 506. If the reactive queue 520 signals such backpressure, at step 502 the bucket unloader waits until the backpressure signal is removed. Backpressure may be removed when entries of reactive queue 520 are emptied in response to pulls from messaging agents within messaging agent network 525.

When it is determined at step 502 that the backpressure signal is withdrawn, and the reactive queue is able to accept input data, at step 503 the bucket unloader retrieves target population information from the buckets and forwards the information to the reactive queue 520 for use by agents in the messaging agent network 525. FIG. 5 represents the forwarding release of the backpressure mechanism as an enable signal to switch 515 which opens the data channel between the bucket unloader and the reactive queue 520, although similar functionality may be implemented in a variety of manners known to those of skill in the art.

Accordingly, a campaign server has been shown and described which uses a multi-level queue architecture and controlled backpressure mechanisms to isolate campaign processing from the delays and inconsistencies of target population information retrieval and campaign server resource fluctuations. Campaign processing is isolated from delays thorugh the use of bucket queues which are managed to maximum fullness, providing a smooth stream of target population for campaign processing as needed. Bucket queues may be further managed based on expected consumption information received from backpressure mechanisms of a reactive queue. As such, target population is consistenly available to consumers and campaigns are not impacted by the delays associated with target population information retrieval. Campaign delivery is isolated from server resource availability fluctuations through the intelligent management of messaging agents, which may be added or removed in accordance with the flucturations. Campaign processing is further isolated from delay thorugh the deployment of multiple independent messaging agents, each capable of handling tasks of varying complexity without impacting performance of other agents. Each queue level may be intelligently controlled to provide backpressure in accordance with both processing demands of coupled messaging agents and available resources. Queues may be automatically controlled to speed up or slow down customer information retrieval in accordance with the progress of campaign processing, and messaging agents may be automatically scaled to maximize campaign processing in accordance with server resources. Because the backpressure signal from the bucket loader takes into account not only the fullness of the buffers but the availability of the reactive buffer (which is driven by actual agent consumption) the rate of data flow into the buckets may be customized to the needs of the campaign. By dynamically deploying and removing the messaging agents to optimally support the campaign in view of system resources, campaign delivery may be optimized for the specific system architecture in which it is deployed. With such an arrangement, various embodiments of the campaign server architecture may be deployed for supporting a wide range of campaign types and populations.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of functional blocks or units that might be implemented as program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but still co-operate or interact with each other.

Various embodiments also relate to apparatuses or systems for performing these operations. This apparatus may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment to streamline the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A campaign server coupled to a plurality of members of a target population via a network, the campaign server comprising:
a processor;
an interface, coupled to the processor and configured to receive a job request related to a campaign to be streamed to the plurality of members of at least one of target population;
a first plurality of non-volatile storage devices allocated to a first plurality of queues, the first plurality of non-volatile storage devices coupled to receive streamed target population information from a coupled target population data store via the interface, each queue comprising a plurality of entries for storing the streamed target population information;
a second plurality of non-volatile storage devices coupled to receive the streamed target population information from the first plurality of queues, the second plurality of non-volatile storage devices organized as a reactive queue comprising a plurality of entries for storing target population information forwarded from the first plurality of queues;
a first backpres sure controller, configured to monitor a capacity of the first plurality of queues to determine when the first plurality of queues reach a threshold capacity, and to further monitor a fullness of the reactive queue, the first backpres sure controller configured to signal the coupled target population data store to stop forwarding the streamed target population information to the first plurality of storage devices in response to the capacity of the first plurality of queues and the fullness of the reactive queue;
a second backpressure controller to control the forwarding of target population information from the first plurality of queues to the reactive queue in response to a fullness of the reactive queue, the second backpressure controller signaling the fullness of the reactive queue to the first backpres sure controller;
a messaging agent builder, coupled to the reactive queue and adapted to (i) generate different forms of program code in accordance with the campaign as messaging agents and deploy the messaging agents to operate on different processors within the network and (ii) dynamically control a population of the messaging agents in response to available resources of the campaign server, a campaign type, a size of the target population or a combination thereof; and
each messaging agent configured to retrieve target population information from the reactive queue and to generate and distribute campaign content to the members of the target population over the network.

2. (canceled)

3. The campaign server of claim 1 further comprising a workstation for receiving campaign control information from a user, the campaign control information including, but not limited to, a target population, a campaign content and a campaign schedule.

4. The campaign server of claim 1 wherein the messaging agent builder selectively generates messaging agents prior to or during campaign delivery in accordance with at least one of available resources or processing capabilities of the campaign server.

5. The campaign server of claim 4 wherein the messaging agent builder selectively removes messaging agents from the population prior to or during campaign delivery in accordance with at least one of available resources, processing capabilities, or job load of the campaign server.

6. The campaign server of claim 1 wherein at least one queue of the plurality of queues comprises a First-In-First-Out queue.

7. The campaign server of claim 1 wherein the reactive queue comprises an array blocking queue.

8. The campaign server of claim 1 further comprising a queue manager, for provisioning memory resources of the campaign server to the plurality of queues in response to the job request.

9. The campaign server of claim 1 wherein a plurality of jobs associated with a plurality of campaigns are received by the campaign server, and at least one messaging agent of the plurality of messaging agents is deployed for processing a different campaign than other messaging agents of the plurality in parallel.

10. The campaign server of claim 1 wherein a messaging agent is selected and deployed for processing the campaign for a particular target population in accordance with a geography of the target population.

11. A method, by a computer implemented campaign server, for streaming campaigns to target populations coupled to the campaign server by a network, the method comprising the steps of:
receiving a job request related to a campaign to be streamed to a plurality of target populations;
streaming target population information for the plurality of target populations from a target population data store coupled to the campaign server to a plurality of queues of the campaign server allocated to a plurality of non-volatile storage devices of the campaign server;
forwarding streamed target population information from the plurality of queues of the campaign server to a reactive queue stored in a non-volatile memory of the campaign server;
monitoring a capacity of the plurality of queues of the campaign server to determine when the plurality of queues reach a threshold capacity;
monitoring a fullness of the reactive queue including precluding the forwarding of target population information to the reactive buffer based on the fullness of the reactive queue;
forwarding target population information from the plurality of queues to the reactive queue in response to both the fullness of the reactive queue and the capacity of the plurality of queues;
generating different forms of program code in accordance with the campaign as messaging agents and deploying the messaging agents to operate on different processors within the network;
dynamically controlling a population of the messaging agents, including generating a plurality of messaging agents in response to available resources of the campaign server, a campaign type, a size of the target population or a combination thereof;
retrieving, by each messaging agent, target population information from the reactive array; and
processing the campaign, at each messaging agent, for target populations identified by target population information retrieved from the reactive queue by the messaging agent, including forwarding campaign content to the target populations.

12. The method of claim 11 further including the step of collecting feedback for the campaign and forwarding the feedback to the plurality of messaging agents.

13. (canceled)

14. The method of claim 11 wherein the step of dynamically controlling includes removing messaging agents from the population during campaign delivery in accordance with at least one of available resources, processing capabilities, or job load of the campaign server.

15. The method of claim 11 wherein the step of dynamically controlling includes adding messaging agents to the population during campaign delivery in accordance at least one of available resources, processing capabilities, or job load of the campaign server.

16. The method of claim 11 wherein the plurality of queues operates using a First-In-First-Out protocol.

17. The method of claim 11 wherein the reactive queue operates using a First-In-First-Out protocol.

18. The method of claim 11 further including the step of provisioning the plurality of queues in the plurality of non-volatile storage devices in response to the job request.

19. The method of claim 11 including the step of receiving a plurality of job requests associated with a plurality of campaigns and processing different campaigns by different messaging agents in parallel.

20. A method of streaming campaigns target populations coupled to a campaign server by a network includes the steps of:
requesting a job associated with a campaign, including identifying a plurality of target populations to receive a campaign content;
populating attributes of a dynamic campaign service, the attributes comprising a queue size, a queue number and a reactive queue size;
deploying the dynamic campaign service, including:
provisioning a plurality of queues within a non-volatile memory to the campaign in accordance with the queue size and queue number;
provisioning a reactive queue within non-volatile memory in accordance with the reactive queue size;
generating different forms of program code in accordance with the campaign as a plurality of messaging agents and deploying the plurality of messaging agents to operate on different processors within the network;
streaming target population information for each of the plurality of target populations to the plurality of queues, including throttling the streaming of the target population information to the plurality of queues in response a backpressure state determined by monitoring an available capacity of the plurality of queues and a fullness of the reactive queue;
forwarding target population information from the plurality of queues to a reactive queue including precluding the forwarding to the reactive queue in response to the fullness of the reactive queue;
retrieving, by each messaging agent, target population information from the reactive queue; and
processing the campaign, by each messaging agent, for target populations identified by target population information retrieved from the reactive queue by the messaging agent, including forwarding campaign content to the target populations.

21. The campaign server of claim 1 wherein the messaging agents are coupled to the reactive queue via a queue streamer, the queue streamer adapted to perform a reverse multiplex operation for operating in response to a selection input from a reactive stream controller to direct target population information to particular messaging agents in response to pull requests from respective messaging agents.
